(19) United States
(12) Patent Application Publication
(10) Pub. No.: US 2002/0091610 A1
(43) Pub. Date: Jul. 11, 2002

(54) Systems and methods for wealth management

(76) Inventor: Mark J. Smith, Mound, MN (US)

Correspondence Address: Schwegman, Lundberg,, Woessner & Kluth, P.A., P.O. Box 2938, Minneapolis, MN, 55402, US

(21) Appl. No.: 10/037,430

(22) Filed: Oct. 25, 2001

Related U.S. Application Data
(63) Continuation of application No. PCT/US00/16804, filed on Jun. 16, 2000.
(60) Provisional application No. 60/139,682, filed on Jun. 16, 1999.

(51) Int. Cl. G06F 17/60

(52) U.S. Cl. 705/36

(57) ABSTRACT

Systems and methods are provided for engineering, manufacturing, procuring and managing a financial product which combines a finance agreement, a life insurance policy, and a securitization mechanism used to create fixed income securities. The present invention includes a computer readable medium having computer executable instructions for performing a method for engineering and managing a financial product. The method includes calculating a first death benefit value, wherein the first death benefit value includes a selected death benefit value for payment to a beneficiary of an insurance policy. A second death benefit value is calculated. The second death benefit component is calculated based on a loan value added to an interest formula value. The interest formula value includes an outstanding loan value multiplied by a selected interest rate percentage. According to the teachings of the present invention, the second death benefit value is added to the first death value component to produce the total death benefit value.

### FIELD OF THE INVENTION

The present invention relates generally to the field of information handling systems. More particularly, the present invention relates to systems and methods for engineering, manufacturing, procuring and managing a financial product which combines a finance agreement, a life insurance policy, and a securitization mechanism used to create fixed income securities.

### BACKGROUND OF THE INVENTION

Traditionally large life insurance transactions require large sums of monies to fund the payments of premiums. Generally, prospective purchasers of these large policies have vast sums of assets. Oftentimes however these prospective buyers lack the needed liquidity (cash) necessary to fund these large premium needs. Buyers of large policies oftentimes are the beneficiaries of appreciation (rates of return) on their assets which make it beneficial to them to maintain a fully invested position rather than have a significant cash position. This “liquidity dilemma” is further magnified by the imposition of taxes on the necessary liquidation of assets to fund the payments of premiums. Furthermore depending on the disposition of the cash used to pay the premium, the payment of the premium itself may trigger some additional transfer taxes on the transaction. After calculating the lost investment opportunity costs & tax costs associated with the transaction (both liquidation and transfer) potential purchasers shy away from the contemplated insurance purchase.

The need and desire for life insurance has not changed for these potential purchasers. However, the economics of traditional purchasing methodology many times prove uneconomic. The reality of a traditional large life insurance transaction as outlined is that it is in essence two separate transactions. The first being the purchase of a life insurance policy and the second transaction being that of a capital markets transaction needed to find the payment of premiums. The efficiency of the transaction is lacking not on the part of the insurance mechanism but on the capital market cost impact. This inefficiency is caused in part because the capital market effects are not addressed in the traditional transaction.

The basic nature of life insurance is that it is a funding vehicle. Typically a policy owner pays a premium and, at the death of the insured, the insurance company pays a death benefit to the policy beneficiary. Again typically, the owner purchased the policy to fund an obligation or liability triggered upon the death of the insured.

Separate from the acquisition of a life insurance policy is the funding of the policy. Any time monies are liquidated from one account (savings, stocks etc.) in order to fund another account (insurance policy) it could be characterized as a capital markets transaction. A capital market transaction is a funding mechanism/vehicle.

The typical large insurance transaction will deploy two funding mechanisms; a life insurance policy which funds a future benefit, and additionally, a capital markets mechanism that funds the insurance policy.

Another explanation, of one particular example of the above problem, is described as follows. The following description of one example of the problem is provided only by way of example, and not by way of limitation. One of ordinary skill in the art will understand that other descriptions of the problem of outlined above equally apply.

Typically the high net worth clients have very low debt and extraordinary creditworthiness. Lending institutions naturally desire to have such as clients. Similarly, insurance companies would rather that such high net asset estates not ignore their company's products. Instead, the insurance companies desire a method to increase the attractiveness of their products.

Clients holding large amounts of assets desire methods for transferring assets from a taxable classification, or status, to vehicles which can hold those assets in a non-taxable status. Life insurance policies, and other like mechanism are a means for transferring wealth and assets while receiving some asset appreciation and avoiding tax penalties. A life insurance policy, for example, is excludable from the gambit of taxes at the time of the insured's death where the life insurance policy is placed in an irrevocable trust held for the benefit of an estate's heirs. The premiums paid on the policy are generally gifted to the heirs. In this scenario, an increasing death benefit policy will realize an appreciation of the cash asset investment. However, a certain group of high net asset estates tend to disfavor investment in life insurance on the basis that the return on their investment for the monies paid into policy premiums will be significantly lower than the return those estates can realize through other uses of those funds. The cost here includes the cost of the premium and the cost of gift tax and the cost of lost opportunity to earn a higher return on those same dollars.

Traditionally, life insurance companies manufacture and sell policies and second the companies manage the money which they earn from the sale of the life insurance policy product. For example, a purchaser pays premiums into the life insurance policy and the insurance company then reinvests the money from these premiums, after costs, generally into AA or AAA investments.

As mentioned above, lending institutions naturally desire to have such as clients. Further, investors such as insurance companies seek fixed income securities as a method for funding long term liabilities.

Thus, there is a need for technical applications which accommodate the motivations of a purchaser of funding vehicle products as outlined in each of the above described transactions. Currently, systems and methods do not exist for synergistically engineering, manufacturing, procuring and managing a financial product which combines a finance agreement, a life insurance policy, and a securitization mechanism used to create fixed income securities. Creating such systems and methods represents a technical problem to be solved.

### SUMMARY OF THE INVENTION

The above mentioned problems for synergistically engineering, manufacturing, procuring and managing a financial product which combines a finance agreement and a life insurance policy and which benefits from life insurance tax benefits, as well as other problems, are addressed by the present invention and will be understood by reading and studying the following specification. The present invention provides systems and methods for engineering, manufacturing, procuring and managing a coterminous funding vehicle which merges an insurance transaction and a capital market transaction into one product. The present invention includes a resulting product which combines the benefits of life insurance at the death of an insured in exchange for a contingent financial liability during the lifetime of the insured. Thus, the present invention includes systems and methods which offer a technical application that embodies the disciplines of insurance, finance and investment and produces a coterminous durationally matched funding structure.

One particular embodiment of the present invention includes a system which deploys two contracts; a life insurance policy, and a finance agreement. According to the teachings of the present invention, both contracts contain certain unique elements that when matched together offer a positive solution, or technical result solution, to the above described problems inherent in large life insurance transactions.

In this embodiment of the system, the life insurance policy includes a total death benefit which has a first death benefit value and a second death benefit value. The first death benefit value includes a selected death benefit value for payment to a beneficiary of the insurance policy. The second death benefit value is calculated based on a loan value, representing a scheduled premium, added to an interest formula value. The interest formula value includes an outstanding loan value multiplied by a selected interest rate percentage. According to the teachings of the present invention, the second death benefit value is added to the first death value component to produce the total death benefit value. Thus, the death benefit is designed to index based on the scheduled premiums accrued with an interest rate. According to the teachings of the present invention, the interest rate can be a fixed or a variable interest rate. This design allows the death benefit to escalate based on a specific formula. By way of explanation, assume the initial death benefit is $20 Million and the scheduled premium is $1 Million payable for five years with an accruing interest factor of 8.50%.

| | Beg of Year | End of Year |
|---|---|---|
| Year | Death Benefit | Death Benefit |
| 1 | $20,000,000 | $21,085,000 |
| 2 | $21,085,000 | $22,262,225 |
| 3 | $22,262,225 | $23,539,514 |
| 4 | $23,539,514 | $24,925,373 |
| 5 | $24,925,373 | $26,429,030 |
| 6 | $24,429,030 | $26,975,497 |
| 7 | $26,975,497 | $27,568,414 |
| 8 | $27,568,414 | $28,211,729 |
| 9 | $28,211,729 | $28,909,726 |
| 10 | $28,909,726 | $29,667,053 |
| 11 | $29,667,053 | . . . |

In one embodiment of the system, the finance agreement features a number of components. A first component of the finance agreement includes a predetermined amount to be disbursed as a fix sum annually for a specific number of years. According to the system of the present invention, the first component is calculated based on a system model. A second calculated component includes a term of the agreement which is for the lifetime of a specific individual or individuals. A third component includes a fixed or variable interest rate established for the duration of the finance agreement A fourth component includes a calculation in which all interest payable according to the fixed interest rate of the finance agreement is capitalized for the duration of the agreement.

One particular embodiment of the present invention includes a computer readable medium having computer executable instructions for performing a method for engineering and managing a financial product. The method includes calculating a first death benefit value, wherein the first death benefit value includes a selected death benefit value for payment to a beneficiary of an insurance policy. A second death benefit value is calculated. The second death benefit component is calculated based on a loan value added to an interest formula value. The interest formula value includes an outstanding loan value multiplied by a selected interest rate percentage. According to the teachings of the present invention, the second death benefit value is added to the first death value component to produce the total death benefit value.

### BRIEF DESCRIPTION OF THE DRAWINGS

FIG. 1 is a diagram of a hardware and operating environment in conjunction with which embodiments of the invention may be practiced.

FIG. 2 is an illustration of an information handling system according to the teachings of the present invention.

FIG. 3 illustrates, in flow diagram form, a sequence for performing methods according to the teachings of the present invention.

FIG. 4 is a graph depicting the total death benefit design.

FIG. 5 illustrates, in block diagram form, that the systems and methods of the present invention provide for a synergistic, coterminous relationship between a life insurance policy and a finance agreement.

FIG. 6, illustrates, in block diagram form, a relational arrangement for the systems and methods according to an embodiment of the present invention.

FIG. 7 illustrates, in block diagram form, an embodiment of the relational arrangement of the systems and methods of the present invention from the product purchasers perspective at a mortality event of the insured.

FIG. 8 illustrates, in block diagram form, an embodiment of the relational arrangement of the systems and methods of the present invention from the finance company's perspective during a lifetime of an insured.

FIG. 9 illustrates an embodiment of a broad relationship perspective covering a pool product owners according to the teachings of the present invention.

### DETAILED DESCRIPTION

In the following detailed description, reference is made to the accompanying drawings which form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

The present invention is implemented using computer based, informational handling systems which have computer readable medium for executing instructions from software means, e.g. programs, which comprise algorithms for carrying out the method embodiments of the present invention. These embodiments include the methods engineering, manufacturing, procuring and managing a financial product which combines a finance agreement and a life insurance policy and which benefits from life insurance tax. In one embodiment, by way of illustration and not limitation, the methods include the benefits of calculating total death benefit values, tracking the insurance companies lending structure, performing profit analysis, performing loan and life insurance policy administration, re-insuring processes, policy value analysis, and other method embodiments which will be understood by one of ordinary skill in the art upon reading this disclosure.

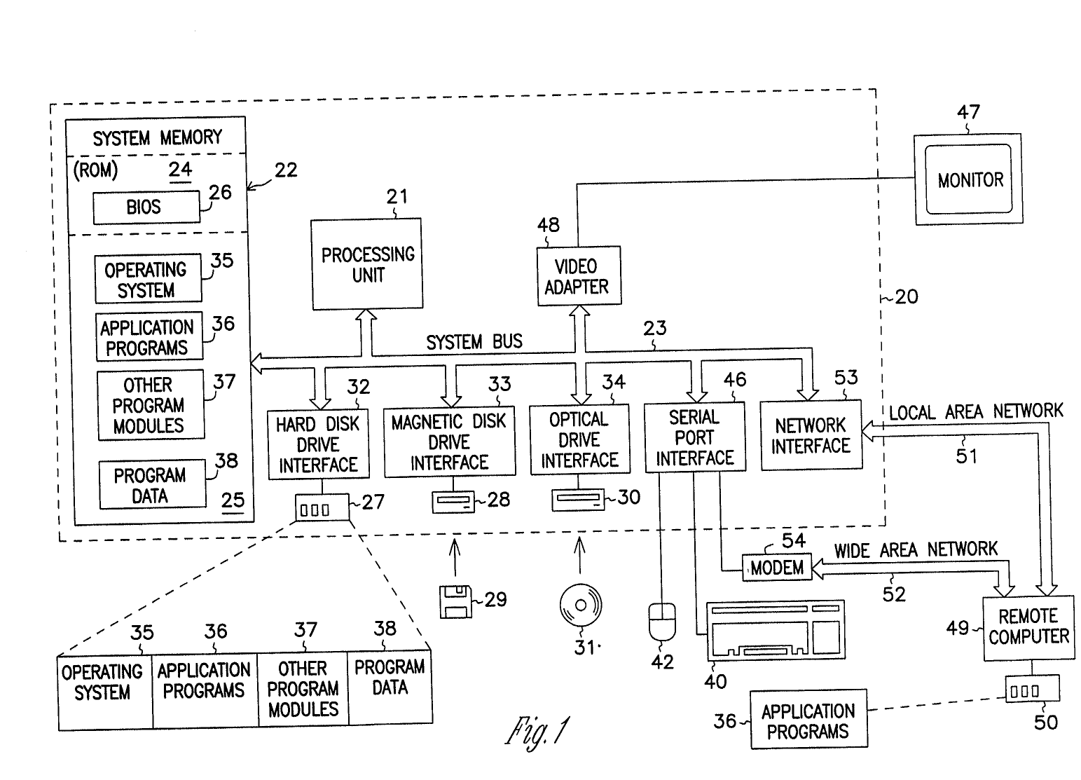

FIG. 1 is a diagram of a hardware and operating environment in conjunction with which embodiments of the invention may be practiced. The description of FIG. 1 is intended to provide a brief, general description of suitable computer hardware and a suitable computing environment in conjunction with which the invention may be implemented. The invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computer environments where tasks are performed by remote processing devices that are linked through a communications network. In a distributed computing environment, program modules may be located in both local and remote memory storage devices.

In the embodiment shown in FIG. 1, the hardware and operating environment of the server 102 and/or the remote client 104 from FIG. 1 includes a general purpose computing device in the form of a personal computer 20, or a server 20, including a processing unit 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer; the invention is not so limited.

The system bus 23 can be any of several types of bus structures including a memory bus or memory controller, a peripheral bus, and a local bus using any of a variety of bus architectures. The system memory can also be referred to as simply the memory, and includes read only memory (ROM) 24 and random access memory (RAM) 25. A basic input/output system (BIOS) 26, containing the basic routines that help to transfer information between elements within the computer 20, or a server 20, such as during start-up, may be stored in ROM 24. The computer 20, or a server 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20, or a server 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), and the like, can be used in the exemplary operating environment.

A number of program modules can be stored on the hard disk, magnetic disk 29, optical disk 31, ROM 24, or RAM 25, including an operating system 35, one or more application programs 36, other program modules 37, and program data 38. A plug in containing a game engine for the present invention can be resident on any one or number of these computer-readable media.

A user may enter commands and information into the personal computer 20, or server 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 40 can display a graphical user interface for the user. In addition to the monitor 40, computers typically include other peripheral output devices (not shown), such as speakers and printers.

The computer 20, or server 20 may operate in a networked environment using logical connections to one or more remote computers or servers, such as remote computer 49. These logical connections are achieved by a communication device coupled to or a part of the computer 20, or server 20; the invention is not limited to a particular type of communications device. The remote computer 49 can be another computer, a server, a router, a network PC, a client, a peer device or other common network node, and typically includes many or all of the elements described above relative to the computer 20, or server 20, although only a memory storage device 50 has been illustrated in FIG. 2. The logical connections depicted in FIG. 2 include a local area network (LAN) 51 and a wide area network (WAN) 52. Such networking environments are commonplace in office networks, enterprise-wide computer networks, intranets and the Internet, which are all types of networks.

When used in a LAN-networking environment, the computer 20, or server 20, is connected to the LAN 51 through a network interface or adapter 53, which is one type of communications device. When used in a WAN-networking environment, the computer 20, or server 20, typically includes a modem 54, a type of communications device, or any other type of communications device, e.g. a wireless transceiver, for establishing communications over the wide area network 52, such as the Internet; the invention is not so limited. The modem 54, which may be internal or external, is connected to the system bus 23 via the serial port interface 46. In a networked environment, program modules depicted relative to the personal computer 20, or portions thereof, can be stored in the remote memory storage device 50 of remote computer, or server 49. It is appreciated that the network connections shown are exemplary and other means of and communications devices for establishing a communications link between the computers may be used.

The hardware and operating environment in conjunction with which embodiments of the invention may be practiced has been described. The computer 20, or server 20, in conjunction with which embodiments of the invention can be practiced can be a conventional computer, a distributed computer, or any other type of computer; the invention is not so limited. Such a computer 20, or server 20, typically includes one or more processing units as its processor, and a computer-readable medium such as a memory. The computer 20, or server 20, can also include a communications device such as a network adapter or a modem, so that it is able to communicatively couple to other computers, servers, or devices.

FIG. 2 is an illustration of an information handling system 200 according to the teachings of the present invention. The information handling system 200 includes a processor 201 and a computer based storage device 202 coupled to the processor. One of ordinary skill in the art will understand upon reading this disclosure the various, commercially available equipment which include a processor 201 coupled to a computer based storage device. In example, the processor 201 and coupled computer based storage device 202 may comprise part of a network system server. In one embodiment, the information handling system 200 may be part of a larger network system which is coupled to a number of remote clients over a local area network (LAN), e.g. an Ethernet network. In an alternative embodiment, the remote clients can be coupled to the information handling system 200 over a wide area network (WAN). Also the remote clients can be coupled to the information handling system 200 over the public switched telephone network (PSTN), via satellite, using wireless application protocol (WAP), and/or the Internet.

The information handling system 200 can further include a mainframe computer as the same are known and understood by one of ordinary skill in the art. The information handling system 200 includes a computer with a computer readable medium having computer executable instructions to cause the computer to perform methods according to the teachings of the present invention. The computer readable medium and computer executable instructions include software for interpreting and executing the computer executable instructions. One of ordinary skill in the art will understand that the systems and method of the present invention include the same. The information handling system may further include network connections to printers and other peripheral devices as the same are known and understood by one of ordinary skill in the art.

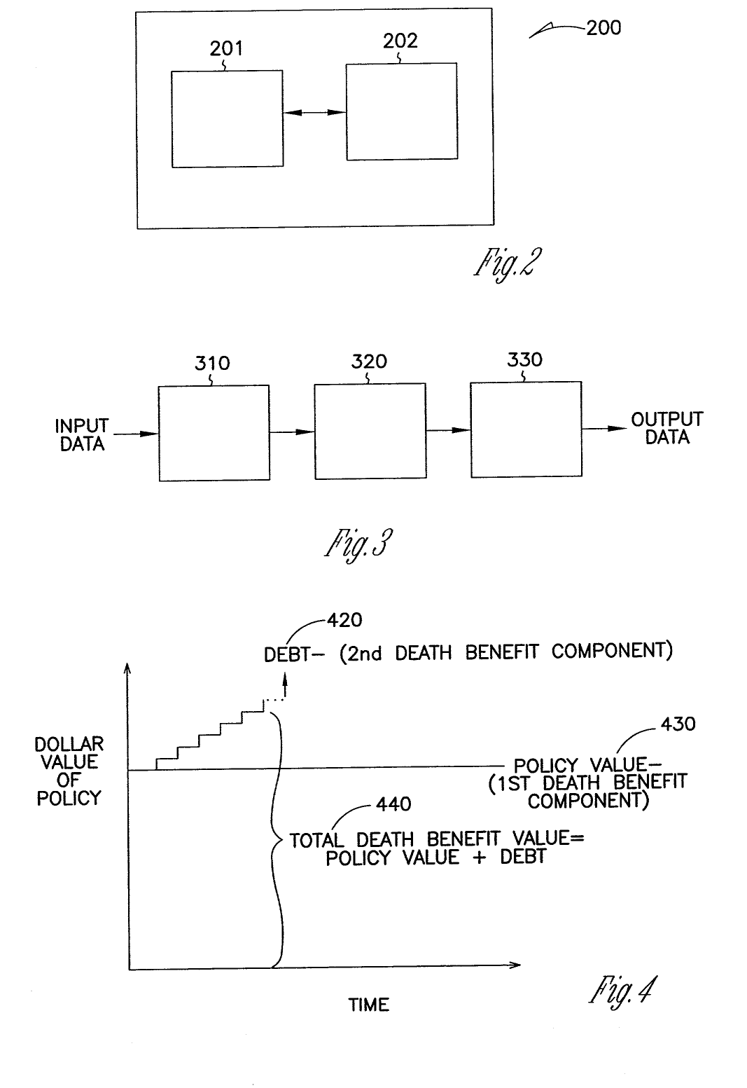

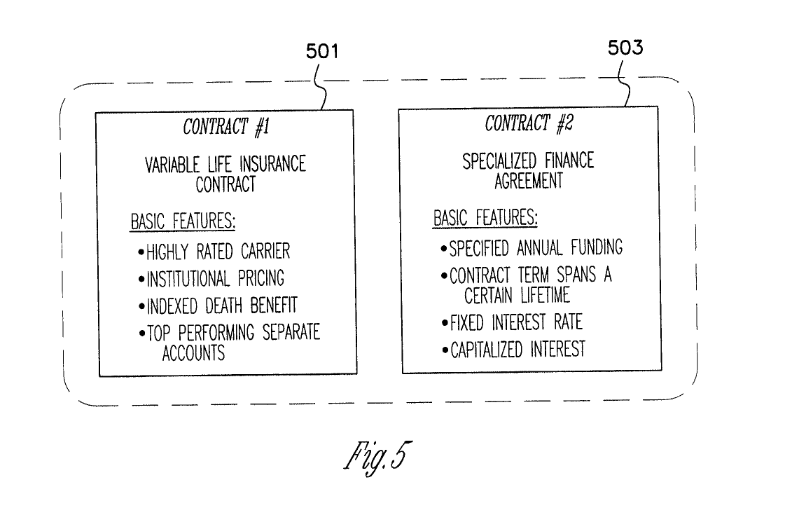

FIG. 3 illustrates, in flow diagram form, a sequence for performing methods according to the teachings of the present invention. As shown in FIG. 3, input data is entered into the information handling system at input block 310. A software program executing on the information handling system shown in FIG. 1 will analyze the input data and allocate the input data to an appropriate processing routing performed by the processor of FIG. 1. One of ordinary skill in the art will understand the manner in which a software program can be launched from memory in a computer based system to execute functions defined in the software program. One of ordinary skill in the art will further understand the various programming languages which may be employed to create a software program suitable for performing algorithms designed implement the methods of the present invention.

The processing routine under the direction of the software program will process the data according to the teachings of the present invention. In calculation block 320, the input data is further interpreted and manipulated according to certain algorithms programmed into to the executing software program in order to perform the methods of the present invention.

At output block 330, the interpreted and manipulated input data is rendered as a resultant data output. The resultant data output can then be stored in the memory storage device. The resultant data can also be output in a printed format or displayed to a remote client over a display device, e.g. monitor or other suitable device. The information handling system of FIG. 1 can similarly retrieve resultant data output from the memory storage device for display or printing at a later point in time.

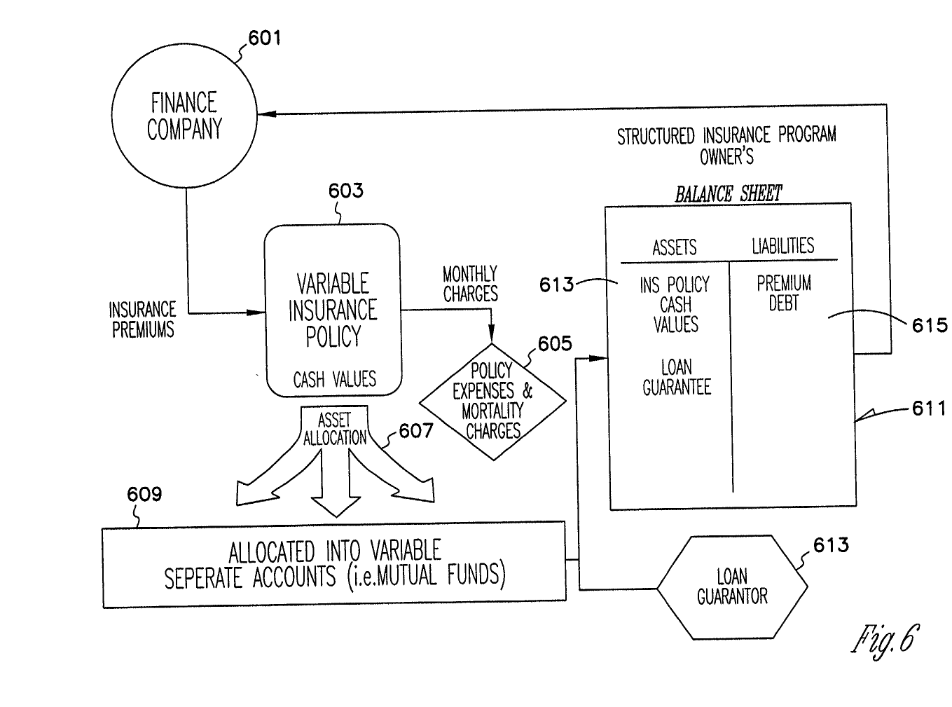

FIG. 4 is a graph which depict the total death benefit design according to the teachings of the present invention. The first death benefit value is shown at 430, the second death benefit value is shown at 420. A total death benefit component is shown at 440. The Y-axis of the graph represents the dollar value of the total death benefit of the life insurance policy and the X-axis represents time.

In one embodiment, the computer readable medium in the information handling system of FIG. 1 has stored on it a data structure according to the teachings of the present invention. This data structure includes a sum of a first calculated death benefit component. The sum of the first death benefit component includes the sum of a premium value added to an interest rate formula. The interest rate formula includes a value which equals the premium value multiplied by a sum of a selected, market based, variable interest rate plus fixed interest rate percentage. According to the teachings of the present invention, the data structure further includes a second death benefit component added to the first death benefit component. The second death benefit component includes a selected death benefit value, or policy value.

As explained in connection with FIGS. 1, 2, and 3, the information handling system comprises a processor, a storage device coupled to the processor, and software means operative on the processor. The information handling system includes a computer with a computer readable medium having computer executable instructions to cause the computer to perform methods according to the teachings of the present invention. The computer readable medium and computer executable instructions include software for interpreting and executing the computer executable instructions. One of ordinary skill in the art will understand that the systems and methods of the present invention include the same. The software means include a software program executing on the information handling system. The software program will analyze the input data and allocate the input data to an appropriate processing routing performed by the processor. The processing routine under the direction of the software program will process the data. Processing the input data includes interpreting and manipulating the input data according to certain algorithms programmed into to the executing software program.

One embodiment of the present invention, provided by way of illustration and not by limitation, includes a product through which life insurance companies can realize an even greater, yet secure, return on this managed money while attracting those same high net worth clients that traditionally avoid such policy investments. To do so the insurance company, finance or credit facility loans the policy purchaser, or to a finance company on behalf of the purchaser, the cost of the premium and additionally amounts to cover interest accrued on the premium loans. The amount of the annual loans of premiums plus interest become a first component of the total death benefit value at the time of the insured's death. The insurance company attains the money to loan the insured by borrowing from a bank or other financial institution. The insurance company borrows the money at a selected, market based, variable interest rate, e.g. the London Inter-Bank Offering Rate (LIBOR), minus some amount of basis points. The insurance company then lends the money to the insured at the same selected, market based, variable interest rate plus some amount, or number of basis points. In return the insurance company books an investment and is assured of making a spread on the financing. In effect, the ladder structure of the annual premium loans amounts the life insurance company provided the equivalent of a zero coupon to Thus, according to the teachings of the present invention the insurance company has de-coupled its return from the performance of the cash value (c.v.) of the life insurance policy As stated the loan to the insured is added as one, or a first, component of the total death benefit value. The other component to the total death benefit value is the value of the policy. At the time of the insured's death the first component is used to repay the loan to the insurance company. The value of the policy is paid to the beneficiary and the proceeds are thus free to be used as desired, e.g. the proceeds can be used to fund liabilities triggered upon the death of the insured. Based on the difference of the cost of the loan to the insurance company and the increased rate at which the insurance company funded the loan to the insured, the insurance company realizes a profit. Meanwhile, the entire process has not come at any cost to the insured. This fact resolves the aversion of the high net asset estate to investing in life insurance policies. Simultaneously, the process creates additional market lending opportunities for the bank. Also, the bank may realize additional market benefit through earning the opportunity to administer the irrevocable trust into which the life insurance policy is placed. Even further, the bank may have the administrative capabilities to create a lock box account through which they handle the administrative details for the life insurance company. In essence the bank can provide underwriting support for the life insurance company.

Initially, the estate of the insured will guarantee the loan amounts provided to the trust to pay the premiums and interest using collateralization from other assets in the insured's estate. In return the trust may provide a letter of credit fee to the estate of the insured. As the life insurance policy cash value grows, the guarantee from the insured's estate is phased out.

The lending value of this process to the insurance company covers initial losses to cash flow which a life insurance company usually incurs in the early years of the life of the insurance policy do to the cost of manufacturing the policy. Further out over the term of the life insurance policy the lending value to the insurance company continues to outperform the insurance value of the life insurance product alone.

Traditionally portions of the life insurance policy are transferred to re-insurance carriers who assume a share of the risk exposure. These re-insurance carriers can be classified a first tier re-insurer class. The risk exposure to this tier of re-insurance carriers is classified as high frequency, low impact. According to the teachings of the present invention, a life insurance policy issued to a high net asset estate involves significantly greater policy values with additional impact risk. Thus, under the present invention, the risk exposure is bi-furcated between the first tier of re-insurance carriers and a second tier re-insurer class. In example, the second tier re-insurer class will assume the accident coverage exposure portion as provided by the terms of the life insurance policy. The risk exposure to this second tier of re-insurance carriers is classified as low frequency, high impact risk exposure. The second tier re-insurance carriers alleviate the additional impact risk which can not be supported traditionally by the first tier.

In one embodiment, by way of illustration and not by way of limitation, processing the input data according to certain algorithms programmed into to the executing software program includes using a series of algorithms which provide a method for calculating a total death benefit value in an insurance policy, e.g. a life insurance policy. According to this embodiment, the series of algorithms, in the software, calculate a first death benefit component. In this embodiment, the first death benefit component is calculated based on input data representing a premium value for the life insurance policy, a selected, market based, variable interest rate, and a fixed interest rate percentage. To calculate the first death benefit component, the algorithms multiply the premium value by an interest rate equal to the sum of the selected, market based, variable interest rate plus fixed interest rate percentage. Alternatively, the first death benefit component is calculated by using the algorithms to add a premium value to an interest rate formula. Here, the interest rate formula includes the premium value multiplied by a sum of a selected, market based, variable interest rate plus fixed interest rate percentage. The series of algorithms include adding a second death benefit component to the first death benefit component. The second death benefit component includes can include input data which represents a selected death benefit value. According to this embodiment, the total death benefit value gradually increases based on a sum of the first death benefit component and the second death benefit component. The total death benefit continues to increase based on the number of intervals at which the above described series of algorithms are repeated by the software program.

In another embodiment, by way of illustration and not by way of limitation, processing the input data according to certain algorithms programmed into to the executing software program includes using a series of algorithms which provide a method for tracking a total death benefit value in a life insurance policy, e.g. storing in a storage device records on the increase of the total death benefit value over time. The graph shown in FIG. 3 illustrates the manner in which the total death benefit value increases over time. The graph of FIG. 3 displays the first death benefit component 320, the second death benefit component 330, and the total death benefit value as a function of time. According to this embodiment, the series of algorithms, in the software means, calculate a first death benefit component at a number of selected intervals, e.g. daily, by the minute, monthly, etc. The first death benefit component is calculated based on a premium value added to an interest rate. The interest rate is determined by using the algorithms in the software means to multiply the premium value a selected, market based, variable interest rate plus a fixed interest rate percentage. At a first selected interval, calculating the first death benefit component comprises only calculating the premium value.

At the number of selected intervals the series of algorithms further add a second death benefit component to the first death benefit component. The second death benefit component includes a selected death benefit value, or policy value. Further, at the number of selected intervals, the software means stores the total death benefit value in the storage device. The total death benefit value which is stored represents the sum of the first death benefit component and the second death benefit component. Thus, the total death benefit value is tracked and stored as the total death benefit value gradually increases over the number of selected intervals at which the above described software means repeats this series algorithms.

In another embodiment, by way of illustration and not by way of limitation, the software means in the computer readable medium, which include computer executable instructions, cause the information handling system, e.g. a computer, to calculate a first death benefit component at number of selected intervals, e.g. hourly, daily, monthly, annually. According to this embodiment, the first death benefit component calculation is based on a selected premium value added to an interest rate formula. The interest rate formula includes an algorithm embedded in the software means. The interest rate formula includes the premium value multiplied by a sum of a selected, market based, variable interest rate plus fixed interest rate percentage. The software means add a second death benefit component to the first death benefit at the selected number of intervals. The second death benefit component includes a selected death benefit value, or policy value. The software means store the total death benefit value in the storage device described above. The total death benefit value is comprised of the sum of the first death benefit component and the second death benefit component. As the software means repeat these described executable instruction at the selected number of intervals, the total death benefit value gradually increases as shown in FIG. 3.

In another embodiment, by way of illustration and not by way of limitation, the software means of the present invention include a series of algorithms for tracking a lending structure. In this embodiment, the series of algorithms in the software means track a number of issued loan amounts made at selected intervals, e.g. dates upon which the loans are funded. The series of algorithms also calculate at selective intervals a number interest amounts. According to this embodiment, at least one of the number of interest amounts is a sum of at least one of the number of loan amounts multiplied by a sum of a selected, market based, variable interest rate plus fixed interest rate percentage. In this embodiment, the series of algorithms in the software means add the at least one of the number of loan amounts to the at least one of the number of interest amounts to calculate a current debt amount. Using the software means of the present invention, the current debt amount is then stored in the storage device portion of FIG. 1. Alternatively, the current debt amount can be reproduced, either on a display device or in printed format, by means of a peripheral device, e.g. monitor or printer, connected to the information handling system.

Another method embodiment of the present invention, by way of illustration and not by way of limitation, an information handing system, or system having software means for performing a profit analysis. Again the software means include an executable software program comprising a series of algorithms for calculating a lending profit and calculating an insurance policy profit. According to this embodiment of the invention, calculating the lending profit includes using a series of algorithms embedded in the software means to calculate a first loan cost based on borrowing a first loan amount at a first interest. Calculating the lending profit further includes using a series, or sequence, of algorithms in the software means to calculate a first return on the first loan cost. Using the algorithms embedded in the software means, the first return on the first loan cost is based on the first loan amount multiplied by an interest rate formula. The interest rate formula includes the first loan amount multiplied by a sum of a selected, market based, variable interest rate plus fixed interest rate percentage. Calculating the insurance policy profit includes using a series of algorithms embedded in the software means for calculating a cost for issuing the insurance policy, calculating a profit for issuing the insurance policy, and calculating a difference between the cost for issuing the insurance policy and the profit for issuing the insurance policy. Finally, performing the profit analysis according to this embodiment, using the software means, includes performing an analysis comparison between the lending profit and the insurance policy profit.

In another embodiment, by way of illustration and not by way of limitation, a software means is provided for re-insuring a life insurance policy. In this embodiment, the software means includes a software program containing a number of algorithms for assigning a first risk exposure to a first tier of re-insurers of the life insurance policy. The first risk exposure is a high frequency, low impact risk exposure. The software means further assigns a second risk exposure to a second tier of re-insurers of life insurance policy. The second risk exposure includes a low frequency, high impact exposure.

In another embodiment, by way of illustration and not by way of limitation, the system of the present invention includes software means comprising a number of algorithms for performing a method of administering a loan and a life insurance policy. The software means uses the number of algorithms to maintain a first database comprising a running sum for a combined loan and accrued interest amount. The software means in the system further uses the number of algorithms to maintain a first database comprising a life insurance policy status. In this embodiment, using the number of algorithms in the software means includes algorithms which re-calculate the loan and accrued interest amount at selected intervals, e.g. hours, minutes, days, etc. Using the number of algorithms in the software means similarly includes algorithms which and re-calculating the life insurance policy status at selected intervals. According to the algorithms used in the present invention, re-calculating the loan and accrued interest amount at selected intervals includes multiplying an outstanding loan amount by an interest rate formula, wherein the interest rate formula includes the outstanding loan amount multiplied by a sum of a selected, market based, variable interest rate plus fixed interest rate percentage.

In another method embodiment of the present invention, by way of illustration and not by way of limitation, the system includes software means for analyzing a the value of a life insurance policy. The algorithms embedded in these software means are used for assessing an outstanding loan amount on the life insurance policy, and analyzing a projected return on the life insurance policy. Analyzing the projected return on the life insurance proceed calculating a lending profit on the life insurance policy over a lending term. Calculating a lending profit includes calculating a total loan cost based on borrowing a number of loan amounts at a first interest, and calculating a return on the total loan cost based on the number of loan amounts multiplied by an interest rate formula, wherein the interest rate formula includes the number of loan amounts multiplied by a sum of a selected, market based, variable interest rate plus fixed interest rate percentage. The software means likewise calculate an insurance policy profit. Here, calculating an insurance policy profit includes calculating a cost for issuing the insurance policy, calculating a profit for issuing the insurance policy, and calculating a difference between the cost for issuing the insurance policy and the profit for issuing the insurance policy. The software means according to the teachings of the present invention further facilitate performing an analysis comparison between the lending profit and the insurance policy profit.

### Preferred Embodiments

Preferred embodiments of the present invention are described in connect with the following text and related Figures. As stated initially, the present invention provides systems and methods for engineering, manufacturing, procuring and managing a financial product which combines a finance agreement and a life insurance policy and which benefits from life insurance tax benefits. FIG. 5 illustrates, in block diagram form, that the systems and methods of the present invention provide for a synergistic, coterminous relationship between a life insurance policy 501 and a finance agreement 503. In one embodiment, as shown in FIG. 5, the life insurance policy 501 includes a variable life insurance contract 501 and the finance agreement 503 includes a specialized finance agreement 503 according to the teachings of the present invention. In one embodiment, a number of basic features of the life insurance policy 501, according to the teachings of the present invention, include the following; a use of a highly rated insurance carrier, institutional pricing, an indexed death benefit, and a use of a number of a number of top performing investment accounts, e.g. top rated mutual funds, for investment of the cash values in the policy. In one embodiment of the system, the finance agreement 503 features a number of components. A first component of the finance agreement includes a predetermined amount to be disbursed as a fix sum annually for a specific number of years. According to the system of the present invention, the first component is calculated based on a system model. A second calculated component includes a term of the agreement which is for the lifetime of a specific individual or individuals. A third component includes a fixed or variable interest rate established for the duration of the finance agreement. A fourth component includes a calculation in which all interest payable according to the fixed interest rate of the finance agreement is capitalized for the duration of the agreement.

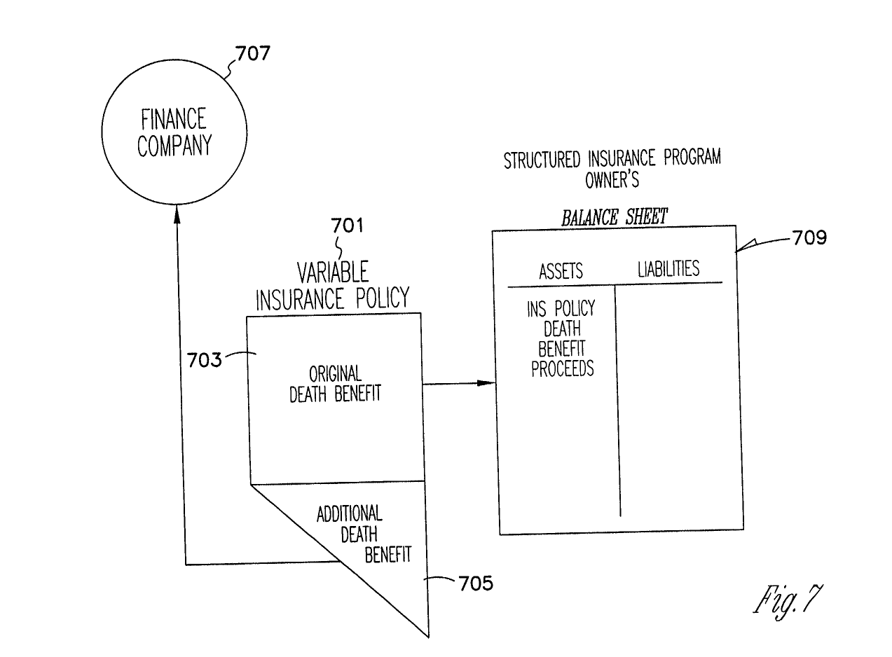

FIG. 6, illustrates, in block diagram form, a relational arrangement for the systems and methods according to an embodiment of the present invention. As shown in FIG. 6, an organization 601, will employ the systems and methods of the present invention to provide a product purchaser, program purchaser, or program owner, with at least two principal agreements, or contracts. Throughout this disclosure the term program is sometimes used interchangeably with the term product. In these instances the use of the term program to reference the finance program of the present invention should not be confused with the underlying software programs employed to carry out the methods of the present invention. One of ordinary skill in the art will understand upon reading this disclosure that the organization 601 using the systems and methods of the present invention can include a finance company, an institutional investment group, a life insurance company, etc. The invention is not so limited. In one embodiment, as indicated above in connection with FIG. 6, a first agreement is a variable life insurance policy and a second agreement is a specialized finance agreement. According to the teachings of the present invention, an owner of the finance agreement will receive a specified annual disbursement equal to a scheduled premium payable on the variable life insurance policy. According to the teachings of the present invention, the program owner will contribute the scheduled premium payable to the variable life insurance policy, shown as block 603, on a due date for the scheduled premium payable. As shown in block 605, the variable life insurance policy incurs a certain number of monthly charges, e.g. a number of policy expenses and mortality charges, as the same are know and understood by one of ordinary skill in the art. Asset allocation occurs as shown at 607. According to the teachings of the present invention, a program owner exercises control over a number of underlying investments of the cash value, or assets, in the variable life insurance policy. Thus, in one embodiment, the variable life insurance policy's cash value can be invested into one or more investment vehicles, shown at block 609. In other words, the program purchaser controls an allocation of the variable life insurance policy's assets into one or more separate accounts, which can be variable, e.g. a number of mutual fund like investments. In this manner, the cash values in the life insurance policy can appreciate.

As will be understood by one of ordinary skill in the art in reviewing FIG. 6, the systems and methods of the present invention, which create a singular product which merging a finance agreement and a life insurance agreement, will create a balance sheet for the program owner, shown at block 611. On an asset side of the balance sheet 611 are an number of assets including a set of cash values in the insurance policy and, in one embodiment, additional collateralization, e.g. a loan guarantee. In other words, in one embodiment of the invention, if program owner does not have a sufficient financial position to secure the finance agreement, based on the asset to liability ratio of the balance sheet, then the purchaser will enlist a support financial position, e.g. a loan guarantee, from a loan guarantor, shown at block 613. In one embodiment, the loan guarantor supplies an additional collateral amount, as needed, to satisfy applicable terms in the finance agreement. On a liabilities side of the balance sheet 615 is included a premium debt, accrued debt, or outstanding loan value. Thus, according to the teachings of the present invention, a risk to a purchaser of the product, including a finance agreement and a life insurance agreement will be an ability to maintain a sufficient asset to liability ratio on the balance sheet. According to the systems and methods of the present invention, a shortfall to a predetermined asset to liability ratio results in a loan repayment triggering event. According to the systems and methods of the present invention, a loan repayment triggering event, results in a liquidation event of the assets, e.g. cash values and any additional collateral/guarantees, for payment of the outstanding loan value. Alternatively, upon the triggering event, the owner of the product has the option of providing additional collateralization to secure the subsequent loan amounts and raise the asset to liability ratio above the predetermined value in order to keep the product in effect. According to the teachings of the present invention, actuarial or monte carlo modeling is performed to set a predetermined value of the asset to liability ratio.

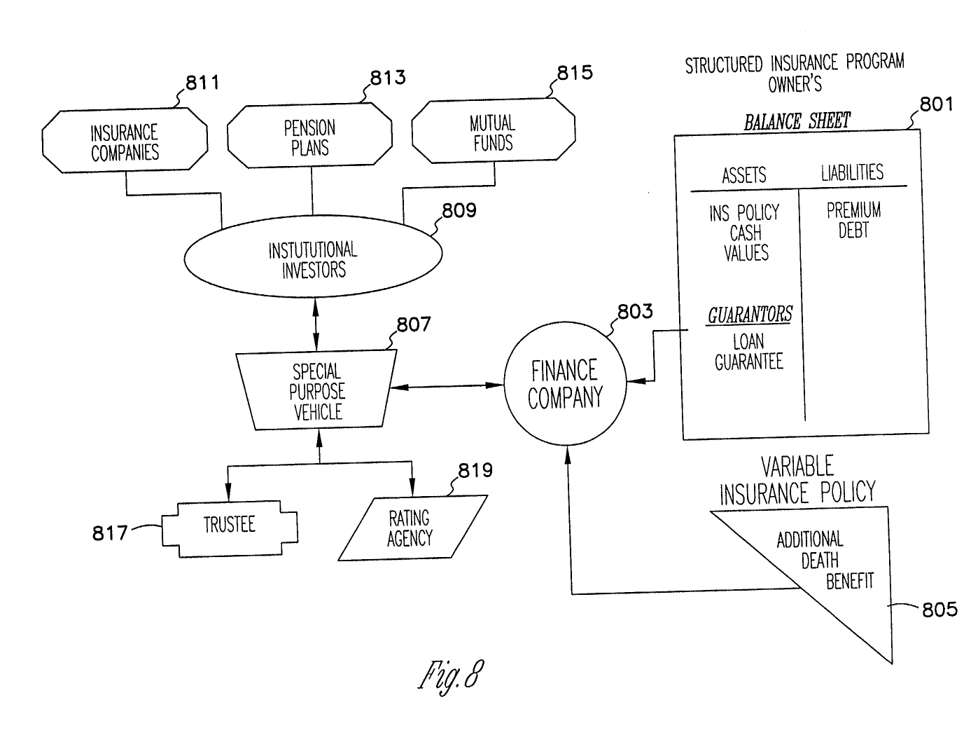

FIG. 7 illustrates, in block diagram form, an embodiment of the relational arrangement of the systems and methods of the present invention from the product purchasers perspective at a mortality event of the insured. As shown at block 701, a variable life insurance policy is included as part of the systems and methods of the present invention. The variable life insurance policy shown in block 701 includes a first death benefit value 703 and a second death benefit value 705. As explained previously in this disclosure, the first death benefit value includes a selected death benefit for payment to a beneficiary of the insurance policy. Further, the second death benefit value includes a loan value added to an interest formula value. The interest formula value includes an outstanding loan value multiplied by a selected interest rate percentage. The second death benefit value is added to the first death benefit value to produce the total death benefit value of the life insurance policy in the product. Upon an occurrence of a mortality event, the second death benefit value 703 is paid to a finance company, or equivalent, shown at block 707 to which the outstanding loan values are owed. In other words, the total loan amounts, representing a debt incurred through the finance agreement on the finance agreement side of the equation to find the accrued premiums and capitalized interest, are repaid to the finance company 707. Also, upon an occurrence of the mortality event, the first death benefit value is paid to the product owner. The product owner then has a balance sheet, shown at block 709, which consists on an asset side of selected death benefit equal to first death benefit value 705. At this point, no liabilities exist on a liabilities side of the balance sheet 709 since the outstanding loan value will have been satisfied in payment of the second death benefit value 703 to the finance company 707. Thus, upon the mortality event of the insured, the novel product which is engineered, manufactured, procured and managed, which combines a finance agreement and a life insurance policy and which benefits from life insurance tax benefits, all according to the systems and methods of the present invention, self completes.

FIG. 8 illustrates, in block diagram form, an embodiment of the relational arrangement of the systems and methods of the present invention from the finance company's perspective during a lifetime of an insured. Block 801 in FIG. 8 shows a balance sheet for the product purchaser. As described above, an asset side includes the insurance policy cash values and, in one embodiment, a collateralized loan guarantee. A liability side of the balance sheet 801 includes a premium debt, or outstanding loan value. The lending organization, or finance company, shown at block 803, which lends the funds necessary to pay the premiums of the life insurance policy is secured during a lifetime of an insured, based on maintaining the predetermined asset to liability ratio for the balance sheet of the product purchaser. As one of ordinary skill in the field of invention will understand upon reading this disclosure, a first line of collateral includes the cash values in the life insurance policy. An additional line collateral, if necessary, is provided by the collateralized loan guarantee. As explained in connection with FIG. 7, the finance company will receive payment of a second death benefit value 805 portion of the total death benefit value for the life insurance policy upon the mortality event, or death, of the insured unless a triggering event occurs prior to the insured's death. One of ordinary skill in the field of invention will understand upon reading this disclosure that, according to the systems and methods of the present invention, the second death benefit value 805 is designed to increase in accordance with the outstanding loan value owed by the product purchaser, e.g. the accrued premium payments and capitalized interest.

In FIG. 8, according to an embodiment of the systems and methods of the present invention, a special purpose vehicle is shown at block 807 which serves as a conduit for an asset backed securities transaction. This special purpose vehicle 807 helps illustrate a number of relational transactions involving the finance agreement, the life insurance policy, an indenture agreement, and a number of guaranteed investment contracts. One of ordinary skill in the art will understand upon reading this disclosure that the term guaranteed investment contract can also be used to represent a guaranteed interest contract and the like. The invention is not so limited.

According to the teachings of the present invention, a life insurance policy is procured which has a total death benefit value comprised of a first death benefit value and a second death benefit value. According to the teachings of the present invention, the life insurance policy is a newly issued policy which is procured for a product purchaser together with a specialized finance agreement with the specific intent of participating in an asset backed securities transaction. As explained above, the first death benefit value includes a selected death benefit value for payment upon a mortality event to a beneficiary of the insurance policy. The finance company 803 procures a finance agreement with terms for providing a loan value to fund the premiums due according to the terms of the life insurance policy. According to the terms of the finance agreement, the loan value is added to an interest formula value which equals an outstanding loan value multiplied by a selected interest rate percentage. The interest rate percentage can be either a fixed or a variable interest rate percentage. According to the teachings of the present invention, actuarial or monte carlo modeling is performed in selecting an appropriate interest rate percentage. The outstanding loan value is recalculated as a number of subsequent loan values are made according to the terms of the finance agreement. Thus, the outstanding loan values equal the second death benefit value of the total death benefit value of the life insurance policy. According to the teachings of the present invention the loan values are accrued and capitalized with the interest formula value over a lifetime of an insured such that a repayment of the outstanding loan values are not due until the death of the insured, absent a triggering event as explained above.

According to the teachings of the present invention, the finance agreement and the life insurance policy are packaged and placed into the special purpose vehicle 807. As shown in FIG. 8, the special purpose vehicle serves as a conduit for a sale of a fixed income security representing a lending arrangement under the terms of the finance agreement. In other words, the sale provides a sum value which represents a present value of the future obligations under the finance agreement. The special purpose vehicle serves as a conduit for procuring and managing an indenture agreement as well as a number of guaranteed investment contract. Funds received from the sale of the fixed income security representing a lending arrangement under the terms of the finance agreement are used to purchase the number of guaranteed investment contracts. The number of guaranteed investment contracts are then used to fund the future obligation of the finance company, or successor finance company under the terms of the finance agreement. The indenture agreement is established in the conduit of the special purpose vehicle in order to govern a right to receive future cash in-flows from a pool of cash assets in the asset backed securities transaction. The special purpose vehicle then is used to provide a disbursement from the pool of cash assets, with an expected yield according to the terms of the indenture agreement, over a number of sequential, durationally termed tranches. According to the teachings of the present invention, actuarial or monte carlo modeling is similarly used to structure the terms of the indenture agreement as well as the number of guaranteed investment contracts.

As shown in FIG. 8, the sale of the fixed income security representing a lending arrangement under the terms of the finance agreement is made to a number of institutional investors, or second party investment entities 809. In one embodiment, the number of institutional investors, or second party investment entities 809 include, but are not limited to; a number of insurance companies 811, a number of pension plans 813, and/or a number of mutual funds. As described in the background of the invention for the present disclosure, numerous second party investment entities 809 desire fixed income securities in order to fund long term liabilities. The systems and methods for engineering, manufacturing, procuring and managing a financial product which combines a finance agreement and a life insurance policy and which benefits from life insurance tax benefits, in effect, produce such fixed income securities. That is, through actuarial mathematics performed using the algorithms contained in the software programs described according to this invention, the life expectancy of a number of insured individuals under the product is computed or calculated. When spread over a volume of insured individuals an expected repayment of the outstanding loan values to the finance company 803 from the second death benefit values 805 becomes a predictable fixed income security, or securities.

The indenture agreement governs the right to receive future cash in-flows from a pool of cash assets in the asset backed securities transaction. The special purpose vehicle then is used to provide a disbursement from the pool of cash assets, with an expected yield according to the terms of the indenture agreement, over a number of sequential, durationally termed tranches to the investment entities 809.

According to the teachings of the present invention, the systems and methods of the present invention can manage and track the sale of the predictable fixed income securities to a number of institutional investors, the payment of future obligations under the terms of the finance agreement, and disbursements from the pool of cash assets.

As mentioned previously, through actuarial mathematics performed using the algorithms contained in the software programs described according to this invention, the life expectancy of an insured in a life policy under the novel product is computed or calculated. When spread over a volume of insured individuals an expected repayment of the outstanding loan values to the finance company 803 from the second death benefit value 805 becomes a predictable fixed income security, or securities. The fixed income securities are asset backed by the balance sheet 801 of the life insurance policy under the product. According to the teachings of the present invention using these systems and methods, a payment due date for the predictable fixed income security, or securities, can be defined over a number of tiers, e.g. a number of tranches. Using the systems and methods of the present invention, the payment according to a series or number of tranches becomes a highly predictable event.

FIG. 8 also shows a trustee at block 817 which can serve to administer the special purpose vehicle 807 using the novel software systems and methods of the present invention. In other words, in one embodiment, the software systems and methods are designed to govern the payment of the fixed asset securities to the number of institutional investors 809 through an indenture agreement. It is expected that rating agencies shown at block 819 will review and rate the fixed asset securities offered through the special purpose vehicle of the present invention. Due to the secure nature of the novel financial product of the present invention, it is expected that any such rating by the rating agencies will be highly favorable, e.g. equivalent to that accorded to AA and AAA investments.

In sum, an advantage to the systems and methods of the present invention rests with the fact that the same can engineer, manufacture, procure and manage a financial product which combines a finance agreement, a life insurance policy and a securitization mechanism used to create fixed income securities. The systems and methods thus work to shift the securitization off of the financial books of a finance company and into the hands of investors. A life insurance policy under the product serves as collateralization during a lifetime of an insured for receipt of loan values, according to the terms of a finance agreement under the product, to pay the premiums of the life insurance policy. Upon a death of the insure, e.g. a mortality event, the second death benefit value serves a the method to repay outstanding loan values. The finance agreement, indenture agreement, and guaranteed investment contracts serve as a method to set various yields to various entities, e.g. the finance company and investors, involved with the novel product.

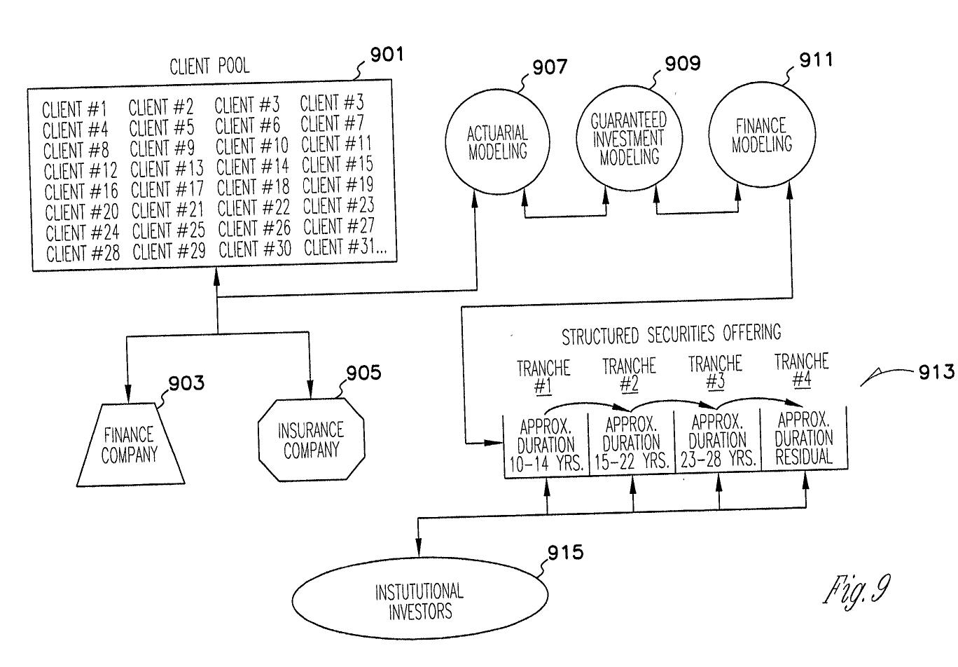

FIG. 9 illustrates an embodiment of a broad relationship perspective covering pool product owners 901 according to the teachings of the present invention. FIG. 9 illustrates that the product relationally involves a finance company 903, an insurance company 905, a number of modeling analyses, including actuarial modeling 907, guaranteed investment modeling 909, and finance modeling 911, to provide a structured securities offering, or asset backed securities transaction which provides returns through a number of tranches 913 to institutional investors 915. The technical problem of a “liquidity dilemma” involved with large life insurance transactions is obviated through the systems and methods of the present invention for engineering, manufacturing, procuring and managing a financial product which combines a finance agreement and a life insurance policy and which benefits from life insurance tax benefits.

In FIGS. 1 and 2, a system or network which includes a processor and storage device has been presented, e.g. such as contained in one or more servers. As one of ordinary skill in the art will understand upon reading this disclosure, the storage device includes a computer readable medium having computer executable instructions. The computer readable medium is not limited to the storage device, however, and can alternatively be a transportable computer medium in the form of a disk. The computer readable medium in the storage device, or on a disk, is comprised of a number of databases having a number of database structures. One of ordinary skill in the art will understand upon reading this disclosure the manner in which numerous database structures can be configured within one or more storage devices and networked to communicatively operate with one another and/or a processor. The computer executable instructions on the computer readable medium include one or more software programs. One of ordinary skill in the art will further understand the various programming languages, such as object oriented programming and the like, which can be used to create the one or more programs. The invention is not so limited. Neither is the present invention limited to a specific set of protocols. One of ordinary skill in the art will understand upon reading this disclosure, the various number of protocols which can be employed in the system or network of the present invention to perform the methods described in the present invention. The processor can execute the computer readable instructions contained in the described computer readable medium to perform the methods of the present invention. The following include embodiments of the present invention employing a computer readable medium having computer readable instruction for performing a method for engineering and managing a novel financial product.

In one particular embodiment, the method includes calculating a first death benefit value. The first death benefit value includes a selected death benefit value for payment to a beneficiary of an insurance policy. The method includes calculating a second death benefit value. The second death benefit value is calculated based on a loan value added to an interest formula value, wherein the interest formula value includes an outstanding loan value multiplied by a selected interest rate percentage. The second death benefit value is added to the first death value component to produce the total death benefit value.

In one embodiment, the method further includes recalculating the second death benefit component based on a number of subsequent loan values, such that the total death benefit value gradually increases as the second death benefit value increases. The method further includes storing the total death benefit value in a storage device.

In one embodiment, the method further includes maintaining a database which has a balance sheet data structure. An asset side of the balance sheet includes a data set of cash values in the insurance policy. A liability side of the balance sheet includes the outstanding loan value which equals the second death benefit value. In this embodiment, the method includes calculating an asset to liability ratio by comparing the asset side to the liability side. In one embodiment, the asset side of the balance sheet further includes a data set of additional collateral value. The method of the present invention includes signaling a triggering event when the asset to liability ratio is below a predetermined ratio. Signaling a triggering event when the asset to liability ratio is below a predetermined ratio includes directing an allocation of the cash values in the insurance policy, or equal to a value of the asset side of the balance sheet data structure to a repayment of the outstanding loan value. It further includes removing the data set of cash values from the asset side of the balance sheet data structure. It also includes removing the second death benefit value from the liability side of the balance sheet data structure and clearing the balance sheet data structure to complete managing the financial product.

In one embodiment, the method includes maintaining a database having a status value for the insurance policy. In this embodiment, the method includes signaling a triggering event when the status value represents a mortality event. According to this embodiment, signaling a triggering event when the status value represents a mortality event further includes directing an allocation of the second death benefit value to a repayment of the outstanding loan value. It includes removing the second death benefit value from the liability side of the balance sheet data structure. And, it includes directing an allocation of the first death benefit value for payment to the beneficiary of the insurance policy and clearing the balance sheet data structure to complete managing the financial product.

In one embodiment of the present invention, the method further includes modeling a number of assets underpinning an asset backed securities transaction. In this embodiment, modeling the number of assets underpinning the asset backed security transaction includes performing a number of actuarial analyses for a number of components of the product. In includes performing a guaranteed investment modeling analysis. It also includes performing a financial modeling analysis, wherein performing a financial modeling analysis includes accounting for an expected yield over a number of sequential, durationally termed tranches which represent a right to receive a set of funds from a pool of cash assets. In this embodiment, performing a number of actuarial analyses for a number of components of the product includes performing an actuarial analysis for the asset backed securities transaction. It includes performing an actuarial analysis for an asset to liability ratio. And, it includes performing an actuarial analysis for a number of individual lifetimes of a group of known clients.

Another particular embodiment of the present invention includes updating the data set of cash values in the asset side of the balance sheet as cash values in the insurance policy change.

One embodiment of the present invention, includes performing a profit analysis. Performing a profit analysis according to the teachings of the present invention includes calculating a lending profit and calculating an insurance policy profit. Calculating the lending profit includes calculating a loan value cost, and subtracting the loan value cost from the interest formula value. Calculating an insurance policy profit includes calculating a cost for issuing and maintaining the insurance policy, and subtracting the cost for issuing and maintaining the insurance policy from a forecasted return value. In this embodiment, performing a lending profit analysis further includes performing a comparison analysis between the lending profit and the insurance policy profit.

In one embodiment of the present invention, the method includes maintaining a database having a data structure representing a number of second death benefit values owned by a number of clients. According to the teachings of the present invention the number of second death benefit values comprise a pool of cash assets. In this embodiment, the method further includes maintaining a database having a data structure representing a number of guaranteed investment contracts which are used to fund a future obligation of a finance company, or a successor of the finance company. In one embodiment, the method further includes maintaining a database having a data structure representing an indenture agreement which governs a right to receive fixture cash in-flows from the pool of cash assets.

According to the teachings of the present invention, the method further includes tracking a number of disbursements from the pool of cash assets. It includes tracking a future obligation of the finance company. It also includes allocating a number of disbursements from the pool of assets to a number of investors. The number of investors are arranged in a database. The number of investors are structured in the database according to a number of sequential, durationally termed tranches. The method also includes allocating a return on investment from the number of guaranteed investment contracts to the future obligation of the finance company.

Another particular embodiment of the present invention includes calculating a loan value cost where calculating the loan value cost includes calculating a cost to sell the number of assets underpinning the asset backed security transaction. It includes calculating a cost to find the future obligation of a finance company, or a successor of the finance company. And, it includes calculating a cost for paying the expected yield over the number of sequential durationally termed tranches, wherein the expected yield is determined by the terms of the indenture agreement which governs the right to receive future cash in-flows from the pool of cash assets.

In one embodiment of the present invention, the method includes tracking a number of future obligations according to the number of terms of a finance agreement. According to the teachings of the present invention, the number of future obligations of the finance agreement include a payment of the loan value and subsequent loan values which are used for payment of premiums in the life insurance policy. The method also includes tracking a value of the interest rate formula.

### Conclusion

Systems and methods are provided for engineering, manufacturing, procuring and managing a financial product which combines a finance agreement, a life insurance policy, and a securitization mechanism used to create fixed income securities. The present invention includes a computer readable medium having computer executable instructions for performing a method for engineering and managing a financial product. The systems and methods thus work to shift the securitization off of the financial books of a finance company and into the hands of investors. A life insurance policy under the product serves as collateralization during a lifetime of an insured for receipt of loan values, according to the terms of a finance agreement under the product, to pay the premiums of the life insurance policy. Upon a death of the insured, e.g. a mortality event, the second death benefit value serves a the method to repay outstanding loan values. The finance agreement, indenture agreement, and guaranteed investment contracts serve as a method to set various yields to various entities, e.g. the finance company and investors, involved with the novel product.

What is claimed is:

1. A computer readable medium having computer executable instructions for performing a method for engineering and managing a financial product, the method comprising:
calculating a first death benefit value, wherein the first death benefit value includes a selected death benefit value for payment to a beneficiary of an insurance policy;
calculating a second death benefit value, wherein the second death benefit component is calculated based on a loan value added to an interest formula value, wherein the interest formula value includes an outstanding loan value multiplied by a selected interest rate percentage; and
adding the second death benefit value to the first death value component to produce the total death benefit value.

2. The computer readable medium of claim 1, wherein the method further includes recalculating the second death benefit component based on a number of subsequent loan values, such that the total death benefit value gradually increases as the second death benefit value increases.

3. The computer readable medium of claim 1, wherein the method further includes storing the total death benefit value in a storage device.

4. The computer readable medium of claim 1, wherein the method further includes:
maintaining a database including a balance sheet data structure, wherein an asset side of the balance sheet includes a data set of cash values in the insurance policy, and wherein a liability side of the balance sheet includes the outstanding loan value which equals the second death benefit value; and
calculating an asset to liability ratio by comparing the asset side to the liability side.

5. The computer readable medium of claim 4, wherein the asset side of the balance sheet further includes a data set of additional collateral value.

6. The computer readable medium of claim 4, wherein the method further includes signaling a triggering event when the asset to liability ratio is below a predetermined ratio.

7. The computer readable medium of claim 1, wherein the method further includes: maintaining a database having a status value for the insurance policy; and
signaling a triggering event when the status value represents a mortality event.

8. The computer readable medium of claim 7, wherein signaling a triggering event when the status value represents a mortality event further includes:
directing an allocation of the of the second death benefit value to a repayment of the outstanding loan value;
removing the second death benefit value from the liability side of the balance sheet data structure; and
directing an allocation of the first death benefit value for payment to the beneficiary of the insurance policy.

9. The computer readable medium of claim 1, wherein the method further includes modeling a number of assets underpinning an asset backed securities transaction, wherein modeling the number of assets underpinning the asset backed security transaction includes:
performing a number of actuarial analyses for a number of components of the product; and
performing a financial modeling analysis, wherein performing a financial modeling analysis includes accounting for an expected yield over a number of sequential, durationally termed tranches which represent a right to receive a set of funds from a pool of cash assets.

10. The computer readable medium of claim 9, wherein performing a number of actuarial analyses for a number of components of the product further includes:
performing an actuarial analysis for the asset backed securities transaction;
performing an actuarial analysis for an asset to liability ratio; and
performing an actuarial analysis for a number of individual lifetimes of a group of known clients.

11. A computer readable medium having computer executable instructions for performing a method for engineering and managing a financial product, the method comprising:
calculating a first death benefit value, wherein the first death benefit value includes a selected death benefit value for payment to a beneficiary of an insurance policy;
calculating a second death benefit value, wherein the second death benefit value is calculated based on a loan value added to an interest formula value, wherein the interest formula value includes an outstanding loan value multiplied by a selected interest rate percentage;
adding the second death benefit value to the first death value component to produce the total death benefit value;
recalculating the second death benefit component based on a number of subsequent loan values, such that the total death benefit value gradually increases as the second death benefit value increases;
maintaining a database including a balance sheet data structure, wherein an asset side of the balance sheet includes a data set of cash values in the insurance policy, and wherein a liability side of the balance sheet includes the second death benefit value; and
calculating an asset to liability ratio by comparing the asset side to the liability side.

12. The computer readable medium of claim 1, wherein the method further includes updating the data set of cash values in the asset side of the balance sheet as cash values in the insurance policy change.

13. The computer readable medium of claim 11, wherein the method further includes performing a profit analysis, wherein performing the profit analysis includes:
calculating a lending profit, wherein calculating a lending profit includes:
calculating a loan value cost; and
subtracting the loan value cost from the interest formula value; and
calculating an insurance policy profit; wherein calculating an insurance policy profit includes:
calculating a cost for issuing and maintaining the insurance policy;
subtracting the cost for issuing and maintaining the insurance policy from a forecasted return value; and
performing a comparison analysis between the lending profit and the insurance policy profit.

14. The computer readable medium of claim 11, wherein the method further includes signaling a triggering event when the asset to liability ratio is below a predetermined ratio.

15. The computer readable medium of claim 14, wherein signaling a triggering event when the asset to liability ratio is below a predetermined ratio includes:
directing an allocation of the cash values in the insurance policy to a repayment of the outstanding loan value;
removing the data set of cash values from the asset side of the balance sheet data structure; and
removing the second death benefit value from the liability side of the balance sheet data structure.

16. The computer readable medium of claim 11, wherein the method further includes:
maintaining a database having a status value for the insurance policy; and
signaling a triggering event when the status value represents a mortality event.

17. The computer readable medium of claim 11, wherein the method further includes:
maintaining a database having a data structure representing a number of second death benefit values owned by a number of clients, wherein the number of second death benefit values comprise a pool of cash assets;
maintaining a database having a data structure representing a number of guaranteed investment contracts which are used to fund a future obligation of a finance company, or a successor of the finance company.

18. The computer readable medium of claim 11, wherein the method further includes:
maintaining a database having a data structure representing a number of second death benefit values owned by a number of clients, wherein the number of second death benefit values comprise a pool of cash assets;
maintaining a database having a data structure representing an indenture agreement which governs a right to receive future cash in-flows from the pool of cash assets.

19. The computer readable medium of claim 17 or 18, wherein the method further includes:
tracking a number of disbursements from the pool of cash assets;
tracking a future obligation of the finance company;
allocating a number of disbursements from the pool of assets to a number of investors, wherein the number of investors are arranged in a database, and the number of investors in the database are structured according to a number of sequential, durationally termed tranches; and
allocating a return on investment from the number of guaranteed investment contracts to the future obligation of the finance company.

20. A computer readable medium having computer executable instructions for performing a method for engineering and managing a financial product, the method comprising:
calculating a first death benefit value, wherein the first death benefit value includes a selected death benefit value for payment to a beneficiary of an insurance policy;
calculating a second death benefit value, wherein the second death benefit value is calculated based on a loan value added to an interest formula value, wherein the interest formula value includes an outstanding loan value multiplied by a selected interest rate percentage;
adding the second death benefit value to the first death value component to produce the total death benefit value;
recalculating the second death benefit component based on a number of subsequent loan values, such that the total death benefit value gradually increases as the second death benefit value increases;
maintaining a database having a data structure representing a number of second death benefit values owned by a number of clients, wherein number of second death benefit values comprise a pool of cash assets;
maintaining a database having a data structure representing a number of guaranteed investment contracts values which are used to fund a future obligation of a finance company, or a successor of the finance company; and
maintaining a database having a data structure representing an indenture agreement which governs a right to receive future cash in-flows from the pool of cash assets.

21. The computer readable medium of claim 20, wherein the method further includes modeling a number of assets underpinning an asset backed securities transaction, wherein modeling the number of assets underpinning the asset backed security transaction includes:
performing a number of actuarial analyses for a number of components of the product;
performing a guaranteed investment modeling analysis; and
performing a financial model analysis, wherein performing a financial modeling analysis includes accounting for an expected yield over a number of sequential, durationally termed tranches.

22. The computer readable medium of claim 21, wherein financial model analysis includes:
calculating a loan value cost, wherein calculating the loan value cost includes:
calculating a cost to sell the number of assets underpinning the asset backed security transaction;
calculating a cost to fund the future obligation of a finance company, or a successor of the finance company; and
calculating a cost for paying the expected yield over the number of sequential durationally termed tranches, wherein the expected yield is determined by the terms of the indenture agreement which governs the right to receive future cash in-flows from the pool of cash assets
subtracting the loan value cost from the interest formula value.

23. The computer readable medium of claim 20, wherein the method further includes:
maintaining a database including a balance sheet data structure, wherein an asset side of the balance sheet includes a data set of cash values in the insurance policy, and wherein a liability side of the balance sheet includes the second death benefit value;
calculating an asset to liability ratio by comparing the asset side to the liability side;
maintaining a database having a status value for the insurance policy; and
signaling a triggering event when either the status value represents a mortality event or when the asset to liability ratio is below a predetermined ratio.

24. The computer readable medium of claim 23, wherein the method further includes directing an allocation of funds equal to the second death benefit value at the mortality event, or equal to a value of the asset side of the balance sheet data structure when the asset to liability ratio is below the predetermined ratio, for payment of the outstanding loan value, and clearing the balance sheet data structure to complete managing the financial product.

25. The computer readable medium of claim 20, wherein the method includes maintaining a database structure which tracks a number of terms of a finance agreement, and wherein the method includes:
tracking a number of future obligations according to the number of terms of the finance agreement, wherein the number of future obligations of the finance agreement include a payment of the loan value and subsequent loan values which are used for payment of premiums in the life insurance policy; and
tracking a value of the interest rate formula.
